(19) United States
(12) Patent Application Publication
(10) Pub. No.: US 2024/0219252 A1
(43) Pub. Date: Jul. 4, 2024

(54) ELECTRONIC COMPONENTS, DETECTION METHOD OF PRESSURE VALUE AND MANUFACTURING METHOD OF ELECTRONIC COMPONENTS

(71) Applicant: ROHM CO., LTD., Kyoto (JP)

(72) Inventor: Kosuke YAMASHIRO, Kyoto (JP)

(73) Assignee: ROHM CO., LTD., Kyoto (JP)

(21) Appl. No.: 18/396,498

(22) Filed: Dec. 26, 2023

(30) Foreign Application Priority Data
Dec. 28, 2022 (JP) 2022-211112

(51) Int. Cl. G01L 13/02; G01L 13/06

(52) U.S. Cl. CPC G01L 13/025; G01L 13/06

(57) ABSTRACT

The present disclosure provides an electronic component. The electronic component includes a cavity, a membrane, deformable in accordance with a difference between a pressure inside the cavity and a pressure outside the cavity and an arithmetic circuit. The membrane includes an opposing portion facing the cavity. One of a peripheral part and a central part of the opposing portion is a thin portion, and another one is a thick portion thicker than the thin portion. The arithmetic circuit is configured to detect a pressure value in a first zone based on a first output value in the thin portion, and detect a pressure value in a second zone higher than the first zone based on a second output value in the thick portion.

### TECHNICAL FIELD

The present disclosure relates to electronic components, a detection method of a pressure value and a manufacturing method of the electronic components.

### BACKGROUND

For example, Japanese Patent Publication No. 2022-71552 (patent document 1) discloses a pressure sensor having a membrane. The pressure sensor detects an external air pressure according to flex of the membrane.

### PRIOR ART DOCUMENT

### Patent Publication

[Patent document 1] Japan Patent Publication No. 2022-71552

### BRIEF DESCRIPTION OF THE DRAWINGS

FIG. 1 is a function block diagram of an electronic apparatus.

FIG. 2 is a cross-sectional view of a pressure sensor.

FIG. 3 is a strain distribution diagram of a membrane of a first experimental example.

FIG. 4 is a strain distribution diagram of a membrane of a second experimental example.

FIG. 5 is a strain distribution diagram of a membrane of a third experimental example.

FIG. 6 is a strain distribution diagram of a membrane of a fourth experimental example.

FIG. 7 is a diagram of a relation between a thickness of a membrane and a sensitivity of a microelectromechanical system (MEMS).

FIG. 8 is an enlarged diagram of the MEMS of the embodiment.

FIG. 9 is a plan view of the MEMS.

FIG. 10 is a diagram for illustrating pads included in the MEMS.

FIG. 11 is a diagram for illustrating pads included in the MEMS.

FIG. 12 is a diagram of a relation between a voltage value from the MEMS and a pressure value detected by a pressure sensor.

FIG. 13 is a flowchart of a detection method of a pressure value.

FIG. 14 is a diagram for illustrating a preparing process.

FIG. 15 is a diagram for illustrating an anti-etch agent configuring process.

FIG. 16 is a diagram for illustrating a trench forming process.

FIG. 17 is a diagram for illustrating a space forming process.

FIG. 18 is a diagram for illustrating a closing process.

FIG. 19 is a diagram for illustrating a cavity forming process.

FIG. 20 is a diagram for illustrating a protection film forming process.

FIG. 21 is a flowchart of a process of main processing of a method for manufacturing a pressure sensor.

FIG. 22 is a diagram for illustrating an anti-etch agent configuring process according to a second embodiment.

FIG. 23 is a diagram for illustrating a trench forming process according to the second embodiment.

FIG. 24 is a diagram for illustrating a space forming process according to the second embodiment.

### DETAILED DESCRIPTION OF THE EMBODIMENTS

Details of embodiments of the present disclosure are provided with the accompanying drawings below. Moreover, the same or equivalent parts are denoted by the same numerals or symbols, and the description is not repeated.

### First Embodiment

### [Configuration of Electronic Apparatus 700]

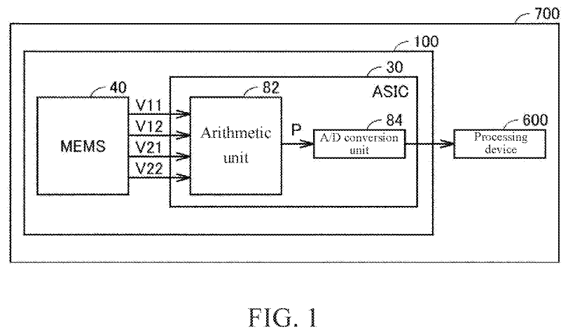

FIG. 1 shows a function block diagram of an electronic apparatus 700. The electronic apparatus 700 is, for example, a mobile terminal. The electronic apparatus 700 includes a pressure sensor 100 and a processing device 600. The pressure sensor 100, for example, detects a pressure of an exterior space of the pressure sensor 100. The pressure sensor 100 includes a microelectromechanical system (MEMS) 40 and an application-specific integrated circuit (ASIC) 30. The ASIC 30 includes an arithmetic unit 82 and an analog-to-digital (A/D) conversion unit 84. The ASIC 30 corresponds to “an arithmetic circuit” of the present disclosure. The pressure sensor 100 corresponds to “an electronic component” of the present disclosure.

As described below, the MEMS 40 includes a membrane that flexes and deforms because of a pressure. The MEMS 40 outputs an analog signal representing a voltage value in the membrane to the ASIC 30. In the example in FIG. 1, analog signals representing voltage values are an analog signal representing a voltage value V11, an analog signal representing a voltage value V12, an analog signal representing a voltage value V21, and an analog signal representing a voltage value V22. The voltage value V11, the voltage value V12, the voltage value V21 and the voltage value V22 are described later.

The arithmetic unit 82 of the ASIC 30 calculates a pressure value P by arithmetic based on equation (1) and equation (2) below, and outputs a pressure signal representing the pressure value P to the A/D conversion unit 84. The A/D conversion unit 84 converts the pressure signal to a digital signal. The A/D conversion unit 84 outputs the digital signal to a processing device 600. The processing device 600 performs processing based on the digital signal. The processing is, for example, displaying the voltage value represented by the digital signal on a display device (not shown).

### [Configuration of Electronic Component]

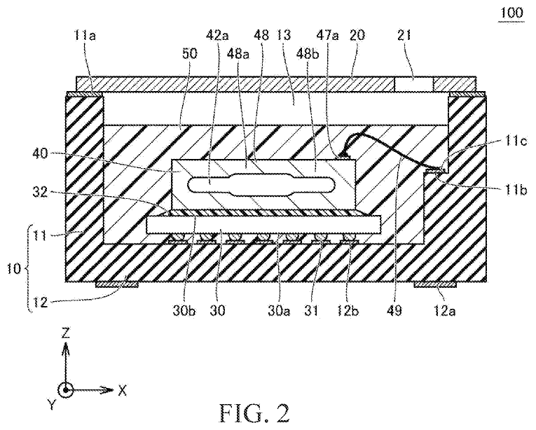

FIG. 2 shows a cross-sectional view of the pressure sensor 100. In this embodiment, a thickness direction of a membrane 48 (described below) included in the pressure sensor 100 is referred to as a Z-axis direction. In other words, the Z-axis direction is a normal direction of the membrane 48. Moreover, two directions perpendicular to the Z-axis direction are also referred to as an X-axis direction and a Y-axis direction.

As shown in FIG. 2, the pressure sensor 100 includes a housing 10, a lid 20, the ASIC 30 and the MEMS 40. The pressure sensor 100 can further include a gel material 50. The housing 10 and the lid 20 form a package casing of the pressure sensor 100. The lid 20 forms an upper wall of the package casing of the pressure sensor 100.

The housing 10 is, for example, made of a ceramic material. The housing 10 has a sidewall 11 and a bottom wall 12. The bottom wall 12 is connected to a lower end of the sidewall 11. Moreover, a space defined by the sidewall 11 and the bottom wall 12 is referred to as an internal space 13. The internal space 13 forms an internal space of the package casing of the pressure sensor 100. The housing 10 has, for example, a rectangular shape in a plan view. An upper end of the sidewall 11 is formed by, for example, a metal layer 11a.

An external connection pad 12a is disposed on an outer wall surface of the bottom wall 12. The pressure sensor 100 is electrically connected to such as a printed circuit board via the external connection pad 12a. Multiple internal connection pads 12b are disposed on an inner wall surface of the bottom wall 12. The internal connection pads 12b are electrically connected to the external connection pad 12a via a conductor (not shown) embedded in the housing 10. A step portion 11b is formed on an inner wall surface of the sidewall 11. An internal connection pad 11c is disposed on the step portion 11b. The internal connection pad 11c is electrically connected to the external connection pad 12a and/or the internal connection pads 12b via a conductor (not shown) embedded in the housing 10.

The lid 20 is a plate-like component. The lid 20 is formed of, for example, a metal material. The lid 20 has, for example, a rectangular shape in the plan view. An outer peripheral part of the lid 20 is joined with the upper end of the sidewall 11 in the plan view. More specifically, the outer peripheral part of the lid 20 is welded at the metal layer 11a in the plan view. Accordingly, the lid 20 forms the upper wall of the package casing of the pressure sensor 100.

A hole 21 is formed at the lid 20. The hole 21 passes through the lid 20 along the thickness direction. From another perspective of the case above, the internal space 13 is in communication with an exterior space of the package casing of the pressure sensor 100 via the hole 21. Moreover, in this embodiment, the number of the hole 21 is one but can also be plural.

The ASIC 30 has a first surface 30a and a second surface 30b. The first surface 30a and the second surface 30b are end surfaces of the ASIC 30 in the thickness direction. The ASIC 30 is disposed on the inner wall surface of the bottom wall 12 to have the first surface 30a face the inner wall surface of the bottom wall 12. On the second surface 30b, the ASIC 30 is electrically connected to the internal connection pads 12b via protrusions 31. The protrusions 31 are formed of, for example, gold.

The MEMS 40 is disposed on the ASIC 30 with an adhesion member 32 interposing in between. Accordingly, the MEMS 40 is disposed at the internal space 13. One outer end 161B of a bonding wire 49 is bonded to a bonding pad 47a, and the other outer end of the bonding wire 49 is joined to the internal connection pad 11c. Thus, the MEMS 40 is electrically connected to the ASIC 30 via the bonding wire 49, the conductor embedded in the housing 10, the internal connection pads 12b and the protrusions 31. The bonding wire 49 is formed of, for example, gold.

The MEMS 40 has a cavity 42a. The cavity 42a is also referred to as a reference pressure chamber. A pressure in the cavity 42a is set as a reference pressure. The cavity 42a is a hollow part in a silicon substrate 160 (referring to FIG. 14) described below.

The MEMS 40 has the membrane 48. In this embodiment, the membrane 48 has a thin portion 48a and a thick portion 48b. The membrane 48 is deformable in accordance with a difference between a pressure (the reference pressure) inside the cavity 42a and a pressure (a pressure of the internal space 13) outside the cavity. In this embodiment, a central part of the membrane 48 is the thin portion 48a. In addition, a peripheral part of the membrane 48 is the thick portion 48b thicker than the thin portion 48a.

### [Strain of Membrane]

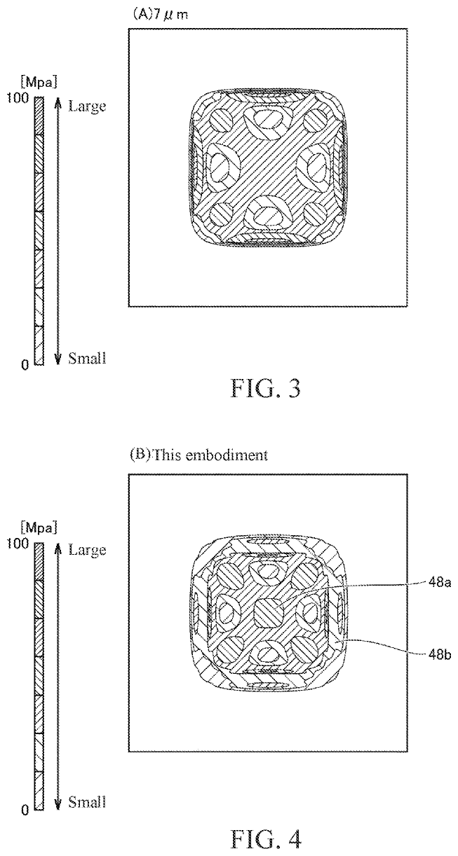

The applicant carried out the following simulation on the MEMS 40 of this embodiment and MEMS of other shapes to measure the strain of the MEMS. In the simulation, an amount of strain in the MEMS is represented by applying an external air pressure of one air pressure to the MEMS 40 of this embodiment and membranes in other shapes. FIG. 3 to FIG. 6 show diagrams of simulation results. In FIG. 3 to FIG. 6, the strain at the part of the membrane in the MEMS is shown while the strain of other parts is not shown.

FIG. 3 is a strain distribution diagram of a membrane of a first experimental example. Both of a central part and a peripheral part of the membrane of the MEMS of the first experimental example are 7 μm. In the example in FIG. 3, it is indicated that a greater strain is produced at the central part and the peripheral part.

FIG. 4 is a strain distribution diagram of a membrane of a second experimental example. The membrane of the second experimental example is equivalent to the membrane 48 of this embodiment. Moreover, in the membrane 48, a thickness of the thin portion 48a which is the central part of the membrane 48 is 5 μm. Moreover, a thickness of the thick portion 48b which is the peripheral part of the membrane 48 is 12 μm. In the example in FIG. 4, it is indicated that the strain of the thick portion 48b is smaller and the strain of the thin portion 48a is greater. In other words, a variation range of strain of the thick portion 48b is narrower, and a variation range of strain of the thin portion 48a is wider than that of the thick portion 48b.

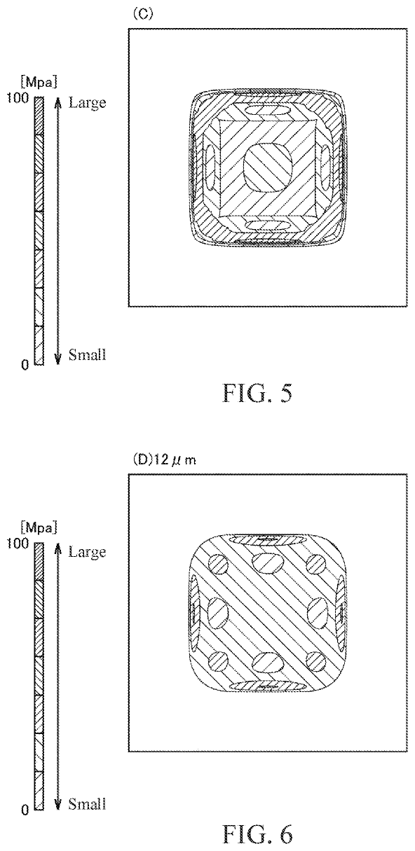

FIG. 5 is a strain distribution diagram of a membrane of a third experimental example. In the membrane of the MEMS of the third experimental example, the central part of the membrane is a thick portion and the peripheral part of the membrane is a thin portion. A thickness of the thin portion is 5 μm, and a thickness of the thick portion is 12 μm. In the example in FIG. 5, similar to FIG. 4, it is indicated that the strain of the thick portion is smaller and the strain of the thin portion is greater.

FIG. 6 is a strain distribution diagram of a membrane of a fourth experimental example. Both of the central part and the peripheral part of the membrane of the MEMS of the fourth experimental example are 12 μm. The membrane of the fourth experimental example is thicker than the membrane of the first experimental example. Thus, in the example in FIG. 6, it is indicated that the strain produced at the central part and the peripheral part of the fourth experimental example is smaller than that of the membrane of the first experimental example.

### [Relation Between Thickness of Membrane and Sensitivity of MEMS]

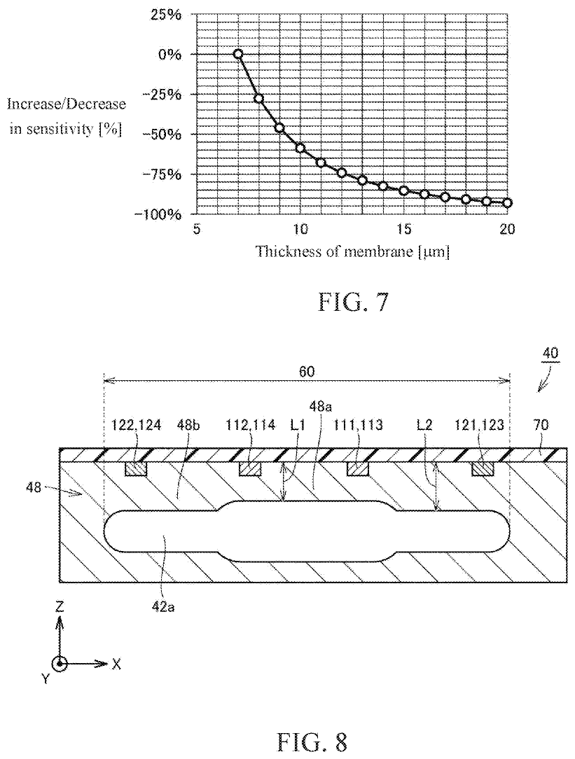

FIG. 7 shows a diagram of a relation between a thickness of a membrane and a sensitivity of a MEMS. In the example in FIG. 7, the vertical axis represents a sensitivity decreasing rate of the MEMS, and the horizontal axis represents the thickness of the membrane. In the example in FIG. 7, an example in which the sensitivity decreasing rate is 0% when the thickness of the membrane is 7.0 μm is shown. As shown in FIG. 7, the sensitivity of the MEMS increases as the thickness of the membrane decreases. The reason for the above is that, as described with reference to FIG. 3 to FIG. 6, the variation range of strain in the membrane reduces when the membrane gets thicker.

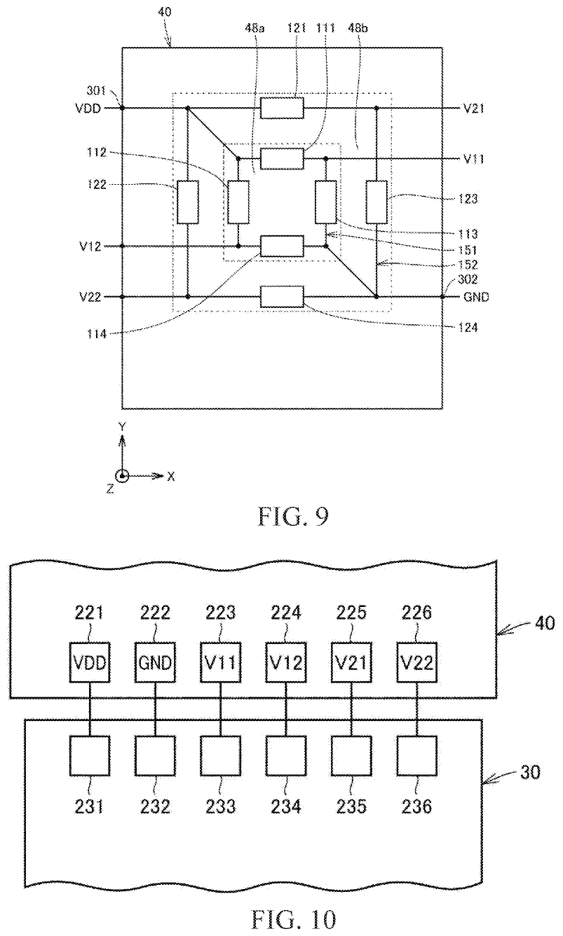

As described below, in the membrane 48 of this embodiment, four strain gauges are disposed in each of the thin portion 48a and the thick portion 48b (referring to FIG. 9). Moreover, the pressure sensor 100 detects pressure values based on voltage values from the strain gauges of the thin portion 48a. Meanwhile, the pressure sensor 100 detects pressure values based on voltage values from the strain gauges of the thick portion 48b.

### [MEMS]

FIG. 8 shows an enlarged diagram of the MEMS 40 of the embodiment. As also shown in FIG. 2, the MEMS 40 includes the cavity 42a and the membrane 48. As shown in FIG. 2 and FIG. 8, the membrane 48 is formed above the Z axis of the cavity 42a. Moreover, the MEMS 40 includes a protection film 70. The protection film 70 is disposed above the Z axis of the membrane 48.

As shown in FIG. 8, the membrane 48 includes an opposing portion 60 facing the cavity 42a in the Z-axis direction. Moreover, the opposing portion 60 has the thick portion 48b and the thin portion 48a. The thin portion 48a (the central part) is an interior part of the thick portion 48b (the peripheral part) on an XY plane. In addition, a thickness L1 of the thin portion 48a is thinner than a thickness L2 of the thick portion 48b. Typically, the membrane 48 refers to a part that flexes in accordance with a pressure. In addition, the opposing portion 60 can also be set as the membrane 48.

In addition, it is determined by the applicant that, a ratio R (=L2/L1) of the thickness L2 of the thick portion 48b to the thickness L1 of the thin portion 48a is preferably between 1.7 and 3.0. By setting the ratio R to the range above, a pressure value in a first zone and a pressure value in a second zone described below can be appropriately detected. In addition, in the example of this embodiment, L1 is set to 5 μm and L2 is set to 12 μm, and it is determined by the applicant that the pressure value the first zone and the pressure value in the second zone can be appropriately detected based on these values. That is to say, typically, the ratio R is 2.4 (=12 μm/5 μm). In addition, in the present application, in addition to including a case where the ratio R is 2.4, the ratio R further includes values different from 2.4 (for example, between 2.2 and 2.6) on the premise that an effect of appropriately detecting the pressure value in the first zone and the pressure value in the second zone can be fully practiced.

Moreover, the MEMS 40 includes at least one interior strain gauge and at least one exterior strain gauge. The pressure sensor 100 detects pressures based on a voltage value of the at least one interior strain gauge and a voltage value of the at least one exterior strain gauge. The at least one interior strain gauge is disposed in the thin portion 48a. In addition, the at least one exterior strain gauge is disposed in the thick portion 48b.

FIG. 9 shows a plan view of MEMS 40 in the z-axis direction and through the protection film 70. FIG. 9 also depicts the thin portion 48a and the thick portion 48b shown in FIG. 8. Strain gauges are shown in FIG. 9.

In the example in FIG. 9, the at least one interior strain gauge disposed in the thin portion 48a includes a first interior strain gauge 111, a second interior strain gauge 112, a third interior strain gauge 113 and a fourth interior strain gauge 114. The at least one exterior strain gauge disposed in the thick portion 48a includes a first exterior strain gauge 121, a second exterior strain gauge 122, a third exterior strain gauge 123 and a fourth exterior strain gauge 124. As such, both of the number of the exterior strain gauges and the number of the interior strain gauges are four, but can also be set to other numbers. Moreover, these eight strain gauges are also shown in FIG. 8.

Moreover, the first interior strain gauge 111, the second interior strain gauge 112, the third interior strain gauge 113, the fourth interior strain gauge 114, the first exterior strain gauge 121, the second exterior strain gauge 122, the third exterior strain gauge 123 and the fourth exterior strain gauge 124 respectively correspond to “a first strain gauge”, “a second strain gauge”, “a third strain gauge”, “a fourth strain gauge”, “a fifth strain gauge”, “a sixth strain gauge”, “a seventh strain gauge”, and “an eighth strain gauge” of the present disclosure.

Next, the effects of the exterior strain gauges and the interior strain gauges are described below. As also indicated by the simulation results of FIG. 3 to FIG. 6, the variation range of strain of the thick portion 48b is narrower while the variation range of strain of the thin portion 48a is wider. When a strain gauge is disposed at the part with a wider strain variation range (that is, the thin portion 48a), a range of the amount of strain of the strain gauge is increased. Thus, since the pressure sensor 100 is capable of detecting a pressure of a large range by the strain gauge, a sensitivity of the pressure sensor 100 can be increased. Thus, the exterior strain gauges disposed in the thick portion 48b are used for pressure detection.

On the other hand, since the variation range of strain of the thick portion 48b is narrower, a sensitivity of the pressure sensor 100 using the exterior strain gauges is lower than a sensitivity of the pressure sensor 100 using the interior strain gauges.

Further, the ASIC 30 of the pressure sensor 100 calculates pressure values based on the first voltage value V1 and the second voltage value V2. The first voltage value V1 is a voltage value of the interior strain gauges of the thin portion 48a. The second voltage value V2 is a voltage value of the exterior strain gauges of the thick portion 48b. In addition, the first voltage value V1 corresponds to “a first output value” of the present disclosure and the second voltage value V2 corresponds to “a second output value” of the present disclosure.

Herein, the first voltage value V1 is a voltage value of the interior strain gauges disposed in the thin portion 48a having a wider stress variation range, and is thus a voltage value corresponding to a pressure value having a higher detection sensitivity. In addition, the second voltage value V2 is a voltage value of the exterior strain gauges disposed in the thick portion 48b having a narrower stress variation range, and is thus a voltage value corresponding to a pressure value having a lower detection sensitivity.

In FIG. 9, a first bridge circuit 151 is formed by the first interior strain gauge 111, the second interior strain gauge 112, the third interior strain gauge 113 and the fourth interior strain gauge 114. More specifically, the first bridge circuit 151 is formed by connecting a first series circuit and a second series circuit in parallel. The first series circuit is a circuit in which the first interior strain gauge 111 and the third interior strain gauge 113 are connected in series. Moreover, the second series circuit is a circuit in which the second interior strain gauge 112 and the fourth interior strain gauge 114 are connected in series.

In addition, a second bridge circuit 152 is formed by the first exterior strain gauge 121, the second exterior strain gauge 122, the third exterior strain gauge 123 and the fourth exterior strain gauge 124. More specifically, the second bridge circuit 152 is formed by connecting a third series circuit and a fourth series circuit in parallel. The third series circuit is a circuit in which the first exterior strain gauge 121 and the third exterior strain gauge 123 are connected in series. The fourth series circuit is a circuit in which the second exterior strain gauge 122 and the fourth exterior strain gauge 124 are connected in series.

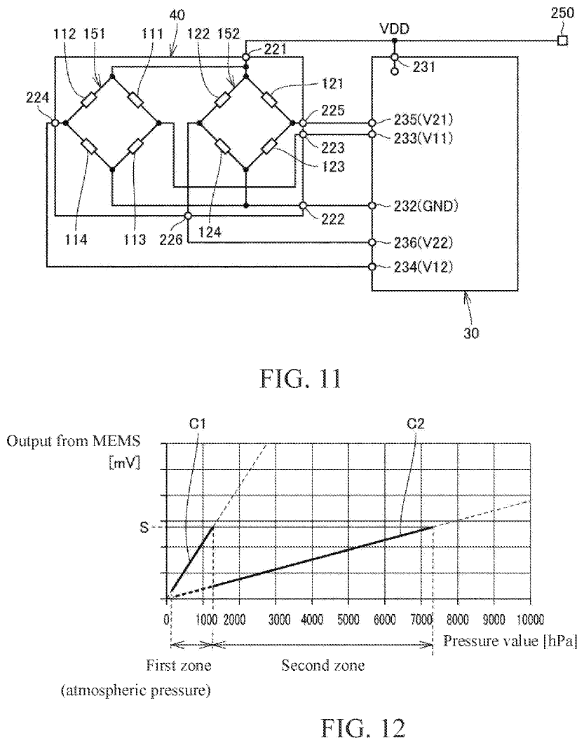

One end of the first exterior strain gauge 121, one end of the second exterior strain gauge 122, one end of the first interior strain gauge 111 and one end of the second interior strain gauge 112 are electrically connected to a VDD terminal (a voltage terminal) 301. The VDD terminal 301 is a terminal used to apply a voltage to the first bridge circuit 151 and the second bridge circuit 152. The voltage is, for example, supplied from a voltage supply terminal 250 (referring to FIG. 11). In this embodiment, the VDD terminal 301 is shared by the first bridge circuit 151 and the second bridge circuit 152. Thus, in the pressure sensor 100, compared to a configuration in which “the VDD terminal is different in the first bridge circuit 151 and the second bridge circuit 152”, the number of the VDD terminal can be reduced.

In addition, one end of the third exterior strain gauge 123, one end of the fourth exterior strain gauge 124, one end of the third interior strain gauge 113 and one end of the fourth interior strain gauge 114 are electrically connected to a GND terminal 302. The GND terminal 302 is a terminal used to ground the first bridge circuit 151 and the second bridge circuit 152. In this embodiment, the GND terminal 302 is shared by the first bridge circuit 151 and the second bridge circuit 152. Thus, in the pressure sensor 100, compared to a configuration in which “the GND terminal is different in the first bridge circuit 151 and the second bridge circuit 152”, the number of the GND terminal can be reduced.

In addition, the MEMS 40, when applied with a voltage from the VDD terminal 301, outputs a voltage value V11, a voltage value V12, a voltage value V21 and a voltage value V22 described below to the ASIC 30 (referring to FIG. 1).

The voltage value V11 is a voltage value between the first interior strain gauge 111 and the third interior strain gauge 113. In addition, the voltage value V12 is a voltage value between the second interior strain gauge 112 and the fourth interior strain gauge 114. The voltage value V21 is a voltage value between the first exterior strain gauge 121 and the third exterior strain gauge 123. The voltage value V22 is a voltage value between the second exterior strain gauge 122 and the fourth exterior strain gauge 124.

In addition, the first voltage value V1 is calculated as a potential difference between the voltage value V11 and the voltage value V12, and the second voltage value V2 is calculated as a potential difference between the voltage value V21 and the voltage value V22, and for example, the first voltage value V1 and the second voltage value V2 are respectively defined by equation (1) and equation (2) below.

$$First voltage value V 1 = V 11 - V 12 \qquad ( 1 )$$

$$Second voltage value V 2 = V 21 - V 22 \qquad ( 2 )$$

FIG. 10 shows a diagram of pads included in the MEMS 40 and pads included in the ASIC 30. The pads of the MEMS 40 include a first pad 221, a second pad 222, a third pad 223, a fourth pad 224, a fifth pad 225 and a sixth pad 226. In addition, the pads of the ASIC include a first pad 231, a second pad 232, a third pad 233, a fourth pad 234, a fifth pad 235 and a sixth pad 236. The first pad 221 to the sixth pad 226 are electrically connected to the first pad 231 to the sixth pad 236, respectively.

The first pad 221 is a pad electrically connected to the VDD terminal 301 (referring to FIG. 9). The second pad 222 is a pad electrically connected to the GND terminal 302 (referring to FIG. 9). The third pad 223 is a pad electrically connected to a terminal outputting the voltage value V11. The fourth pad 224 is a pad electrically connected to a terminal outputting the voltage value V12. The fifth pad 225 is a pad electrically connected to a terminal outputting the voltage value V21. The sixth pad 226 is a pad electrically connected to a terminal outputting the voltage value V22.

FIG. 11 shows a diagram illustrating the first pad 221 to the sixth pad 226 and the first pad 231 to the sixth pad 236 from a perspective different from that of FIG. 10. As shown in FIG. 11, a voltage is applied from the voltage supply terminal 250 to the first bridge circuit 151, the second bridge circuit 152 and the ASIC 30.

### [Relation Between MEMS Output and Pressure Value]

FIG. 12 shows a diagram of a relation between a voltage value (an output value) from the MEMS 40 and a pressure value detected by the pressure sensor 100. In the example in FIG. 8, the vertical axis represents the MEMS output and the horizontal axis represents the pressure value. FIG. 12 shows Table-C1 and Table-C2. Sensitivities shown in Table-C1 are higher than sensitivities shown in Table-C2.

Table-C1 is a table showing the voltage values from the interior strain gauges in the thin portion 48a, and the pressure values detected by the pressure sensor 100 based on these voltage values. Table-C2 is a table showing the voltage values from the exterior strain gauges in the thick portion 48b, and the pressure values detected by the pressure sensor 100 based on these voltage values.

As shown in FIG. 12, a predetermined value S is defined as an upper limit of a voltage value. It is assumed that a configuration using an overly large voltage value to detect a pressure value is considered. However, in the configuration above, the following issues may be generated. The issues include at least one of an issue of an increased processing load in the ASIC, and a reduced detection sensitivity for pressure values. Thus, in this embodiment, the predetermined value S is defined as the upper limit of the output voltage value. The pressure sensor 100 of this embodiment does not employ any output voltage value higher than the predetermined value S. Thus, the issues above can be inhibited.

In addition, as shown in FIG. 12, a zone of the detectable pressure values in Table-C1 is represented as a first zone, and a zone of the detectable pressure values in Table-C2 is represented as a second zone. Herein, the second zone is a zone higher than the first zone. More specifically, a lower limit of the second zone is greater than the upper limit of the first zone. Moreover, the second zone is wider than the first zone by an amount by which the sensitivity of the second zone is lower than that of the first zone. The first zone includes the atmospheric pressure. Thus, the pressure value in the first zone is, for example, a pressure value on flat ground. In addition, the pressure value in the second zone is, for example, a pressure value in the sea (a water pressure value). The arithmetic unit 82 of the ASIC 30, for example, includes a first able corresponding to Table-C1 and a second table corresponding to Table-C2. The arithmetic unit 82 can also include calculation equations corresponding to the first table and the second table.

### [Detection Method of Pressure Value]

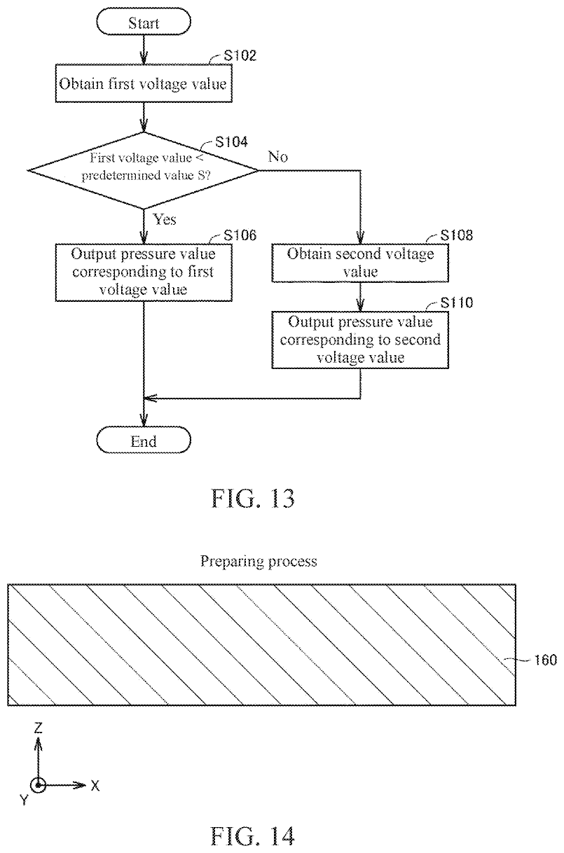

FIG. 13 shows a flowchart of a method for detecting a pressure value by using the arithmetic unit 82 (referring to FIG. 1) of the ASIC. The processing in the flowchart is performed in a predetermined period (for example, at an interval of 1 second).

First of all, in step S102, the arithmetic unit 82 obtains the first voltage value V1 (equation (1)). Then, in step S104, it is determined whether the first voltage value V1 is less than the predetermined value S (referring to FIG. 12). When the first voltage value V1 is less than the predetermined value S (“YES” in step S104), in step S106, the arithmetic unit 82, with reference to the first table, calculates the pressure value corresponding to the first voltage value and outputs the pressure value. The pressure value is a pressure value in the first zone.

In addition, in step S104, when the first voltage value V1 is greater than the predetermined value S (“NO” in step S104), in step S108, the arithmetic unit 82 obtains the second voltage value V2 (equation (2)). Further, in step S110, the arithmetic unit 82, with reference to the second table, calculates the pressure value corresponding to the second voltage value and outputs the pressure value. The pressure value is a pressure value in the second zone.

As described above, the pressure sensor 100 detects the pressure value in the first zone based on the first output value (for example, the first voltage value V1 represented by equation (1)) in the thin portion 48a. In addition, the pressure sensor 100 detects the pressure value in the second zone higher than the first zone based on the second output value (for example, the second voltage value V2 represented by equation (2)) in the thick portion 48b (referring to FIG. 12). Thus, by using one pressure sensor 100, the pressure value in the first zone can be detected, and the pressure of the second zone higher than the first zone can also be detected.

In addition, as shown in FIG. 8 and FIG. 9, the thin portion 48a is the central part of the opposing portion 60. In addition, the thick portion 48b is the peripheral part of the opposing portion 60. Thus, by using a rather simple configuration, the thin portion 48a and the thick portion 48b can be formed.

In addition, as shown in FIG. 13, when the first voltage value V1 is less than the predetermined value S (“YES” in step S104), the pressure sensor 100 detects a pressure value corresponding to the first voltage value V1. In addition, when the first voltage value V1 is greater than the predetermined value S (“NO” in step S104), the pressure sensor 100 detects a pressure value corresponding to the second voltage value V2. Thus, a pressure value of a corresponding condition can be detected.

In addition, the MEMS 40 includes at least one interior strain gauge and at least one exterior strain gauge. The ASIC 30 detects the pressure value in the first zone based on the first voltage value V1 in the at least one interior strain gauge. Meanwhile, the ASIC 30 detects the pressure value in the second zone based on the second voltage value V2 in the at least one exterior strain gauge. Thus, the pressure sensor 100 can use strain gauges which are generally known components to detect the pressure value in the first zone and the pressure value in the second zone.

In addition, as shown in FIG. 9, four strain gauges are disposed in each of the thin portion 48a and the thick portion 48b of the MEMS 40 to detect the first voltage value V1 and the second voltage value V2. Thus, for example, compared to a configuration in which two strain gauges are disposed in each of the thin portion 48a and the thick portion 48b, detection precision for pressure values can be enhanced.

### <Manufacturing Method>

Next, the manufacturing method of the pressure sensor 100 is described. The Bosch process is used in a trench forming process and a space forming process described below. In the Bosch process, an etching step and a protection step are primarily alternately performed.

FIG. 14 to FIG. 20 are diagrams for illustrating the manufacturing method of the pressure sensor 100. FIG. 14 shows a diagram for illustrating a preparing process. In the preparing process, a substrate 160 including a semiconductor layer is prepared. The semiconductor layer is, for example, a silicon layer.

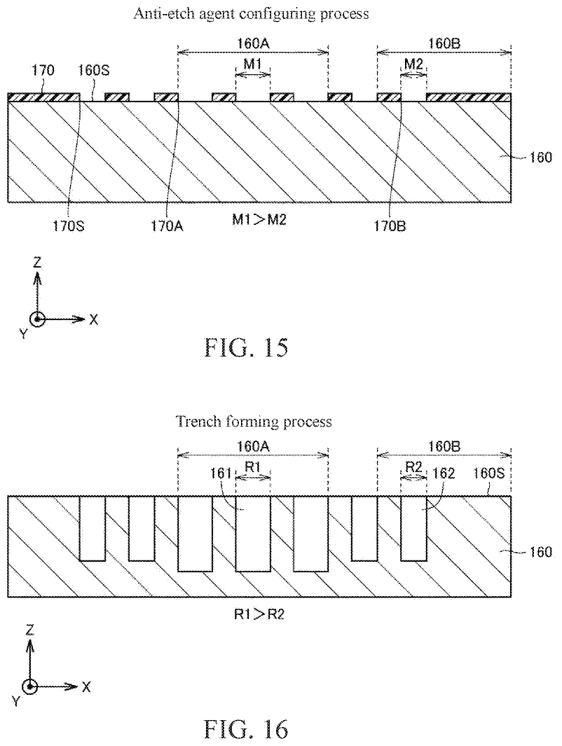

FIG. 15 shows a diagram for illustrating an anti-etch agent configuring process. An anti-etch agent 170 is disposed on an upper surface 160S of the substrate 160. The anti-etch agent 170 is formed to have multiple through holes 170S in two-dimensional manner (on the XY plane). The through holes 170S correspond to first trenches 161 and second trenches 162 below.

A region in the upper surface 160S to become the thin portion 48a is referred to as a central region 160A, and a region to become the thick portion 48b is referred to as a peripheral region 160B. In the through holes 170S of the anti-etch agent 170, a diameter of the through holes 170A in the central region 160A is M1, and a diameter of the through holes 170B in the peripheral region 160B is M2, where M1>M2.

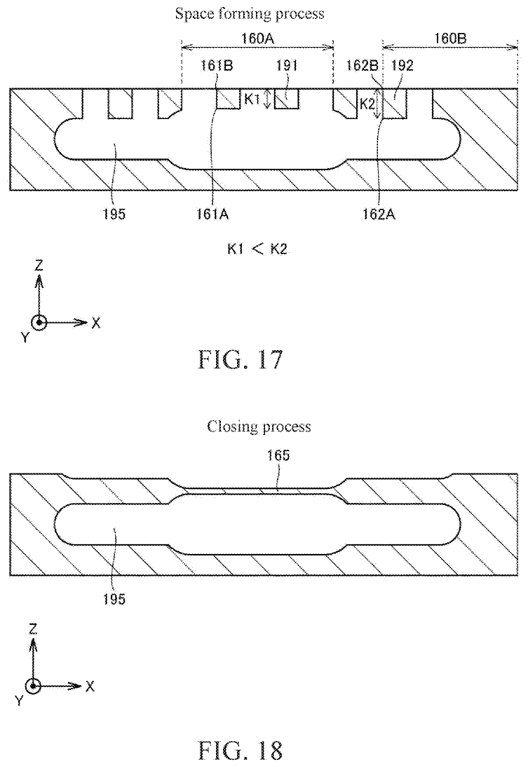

FIG. 16 shows a diagram for illustrating a trench forming process. In the trench forming process, an etching step is performed in case where the anti-etch agent 170 is disposed on the substrate 160. In the etching step, a specified etching material flows to the substrate 160. The etching material includes at least one of an etching gas and a liquid for etching. In this embodiment, an etching gas is used as the etching material since the Bosch process is used as described above. In addition, the etching gas is, for example, sulfur hexafluoride. In addition, in FIG. 16 and FIG. 17, the protection step in the Bosch process is not depicted. In addition, in FIG. 16 and FIG. 17, the anti-etch agent 170 is not depicted either.

With the Bosch process employing the anti-etch agent 170, the first trenches 161 corresponding to the through holes 170A and the second trenches 162 corresponding to the through holes 170B are formed in the substrate 160. The first trenches 161 are trenches formed in the central region 160A. In addition, the second trenches 162 are trenches formed in the peripheral region 160B.

Herein, as described above, the diameter M1 of the through holes 170A is greater than the diameter M2 of the through holes 170B of the anti-etch agent 170. Thus, as shown in FIG. 16, a diameter R1 of the first trenches 161 corresponding to the through holes 170A is greater than a diameter R2 of the second trenches 162 corresponding to the through holes 170B. In addition, the amount of the etching gas flowing per unit area to the substrate 160 is the same as those in the through holes 170A and the through holes 170B. Thus, more etching gas flows in the through holes 170A than in the through holes 170B. Accordingly, a depth of the first trenches 161 corresponding to the through holes 170A is formed to be greater than a depth of the second trenches 162 corresponding to the through holes 170B. That is to say, a volume of the first trenches 161 is greater than a volume of the second trenches 162.

FIG. 17 shows a diagram for illustrating a space forming process. The space forming process is a process of further performing the Bosch process in a case where the first trenches 161 and the second trenches 162 have been formed. In the substrate 160, remaining parts other than the first trenches 161 and the second trenches 162 are also referred to as “residual parts”.

By means of continuing the Bosch process, a space 195 is formed on ends of the multiple trenches (the first trenches 161 and the second trenches 162) at an interior side of the substrate 160. The ends include interior ends 161A of the first trenches 161 and interior ends 162A of the second trenches 162. In addition, as depicted in FIG. 16, the volume of the first trenches 161 is greater than the volume of the second trenches 162. Thus, more etching gas flows in the first trenches 161 than in the second trenches 162. Thus, a length K1 (a depth) of the residual parts 191 in the central region 160A is shorter than a length K2 of the residual parts 192 in the peripheral region 160B.

FIG. 18 shows a diagram for illustrating a closing process. In the closing process, annealing is performed, for example. In the example in FIG. 18, thermal treatment is performed on the substrate 160 in a hydrogen-containing high-temperature (for example, 1100 degrees to 1200 degrees) atmosphere. Further, the ends of the multiple trenches at the exterior side of the substrate 160 are closed by melting a part 165 of the substrate 160 using the thermal treatment. The ends include exterior ends 161B of the first trenches 161 and exterior ends 162B of the second trenches 162.

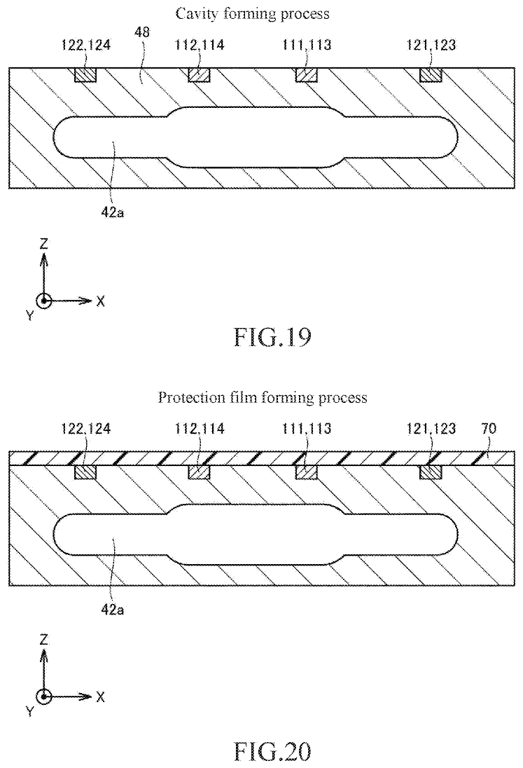

FIG. 19 shows a diagram for illustrating a cavity forming process. In the cavity forming process, an upper portion of the substrate 160 is thickened by plasma deposition to form the membrane 48. In addition, the eight strain gauges (the first interior strain gauge 111, the second interior strain gauge 112, the third interior strain gauge 113, the fourth interior strain gauge 114, the first exterior strain gauge 121, the second exterior strain gauge 122, the third exterior strain gauge 123 and the fourth exterior strain gauge 124) are disposed.

FIG. 20 shows a diagram for illustrating a protection film forming process. As shown in FIG. 20, the protection film 70 (referring to FIG. 8) is formed on an upper portion of the substrate 160. Further, the pressure sensor 100 such as that shown in FIG. 2 is manufactured by disposing other components such as the ASIC 30.

In the cavity forming process above, the cavity 42a and the membrane 48 are formed to have the thickness L1 of the thin portion 48a of the opposing portion 60 be thinner than the thickness L2 of the thick portion 48b of the opposing portion 60. Thus, with the manufacturing method of this embodiment, the pressure sensor 100 capable of detecting the pressure value in the first zone and the pressure value in the second zone can be manufactured.

In addition, as depicted in FIG. 16, the diameter R1 of the first trenches 161 is formed to be greater than the diameter R2 of the second trenches 162. With the simple method above, the thickness L1 of the thin portion 48a of the opposing portion 60 can be formed to be thinner than the thickness L2 of the thick portion 48b of the opposing portion 60.

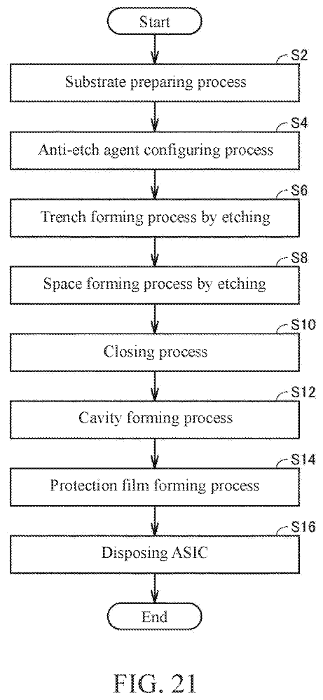

FIG. 21 shows a flowchart of process of main processing of a manufacturing method of the pressure sensor 100. In step S2, the substrate 160 is prepared (referring to FIG. 14). Next, in step S4, an anti-etch agent is disposed (referring to FIG. 15). Next, in step S6, multiple trenches are formed by etching (referring to FIG. 16).

Next, in step S8, the space 195 is formed by etching (referring to FIG. 17). Next, in step S10, the closing process is performed by annealing, for example (referring to FIG. 18). Next, in step S12, the membrane 48 is formed by plasma deposition (referring to FIG. 19). Next, in step S14, the protection film 70 is formed (referring to FIG. 20). Next, in step S16, the ASIC 30 is disposed (referring to FIG. 2).

### Second Embodiment

In the first embodiment, a method to have the thickness L1 of the thin portion 48a of the opposing portion 60 to be thinner than the thickness L2 of the thick portion 48b of the opposing portion 60 as well as a method to have the diameter R1 of the first trenches 61 to be less than the diameter R2 of the second trenches 162 are described. In the second embodiment, another method to have the thickness L1 to be thinner than the thickness L2 is described.

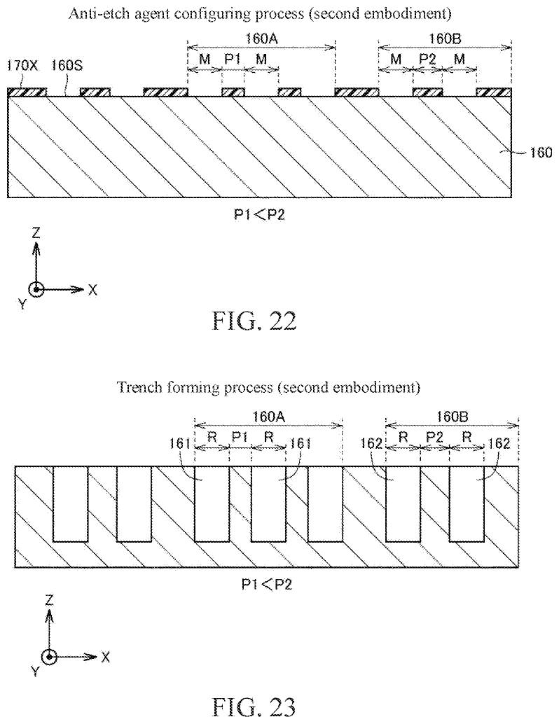

FIG. 22 shows a diagram for illustrating an anti-etch agent configuring process according to the second embodiment. In the through holes 170S of an anti-etch agent 170X of the second embodiment, the diameter of the through holes 170A in the central region 160A and the diameter of the through holes 170B in the peripheral region 160B are the same, and are both set to M. In addition, an interval P1 between two adjacent through holes 170A in the central region 160A is narrower than an interval P2 between two adjacent through holes 170B in the peripheral region 160B.

FIG. 23 shows a diagram for illustrating a trench forming process according to the second embodiment. As shown in FIG. 23, an interval between two first trenches 161 in the central region 160A of the substrate 160 is P1. In addition, an interval between two second trenches 162 in the peripheral region 160B of the substrate 160 is P2. In addition, by using the anti-etch agent 170X in FIG. 22, the diameter of all the first trenches 161 and the diameter of all the second trenches 162 are formed to have the same diameter R. Further, by using the anti-etch agent 170X in FIG. 22, the interval P1 is formed to be smaller than the interval P2.

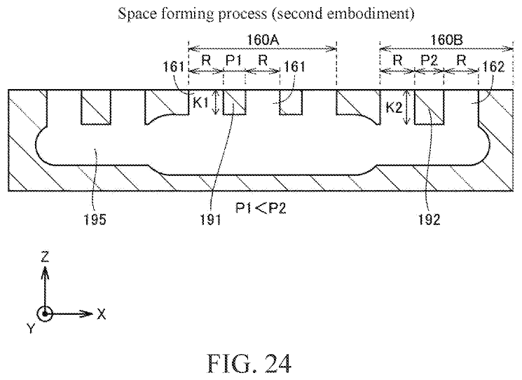

FIG. 24 shows a diagram for illustrating a space forming process according to the second embodiment. The interval P1 in the anti-etch agent 170X is less than the interval P2. Thus, the amount of etching gas flowing per unit area in the central region 160A is greater than the amount of etching gas flowing per unit area in the peripheral region 160B. Thus, as shown in FIG. 24, the length K1 (the depth) of the residual parts 191 in the central region 160A is shorter than the length K2 of the residual parts 192 in the peripheral region 160B.

Thus, in the cavity forming process above, the cavity 42a and the membrane 48 are formed to have the thickness L1 of the thin portion 48a of the opposing portion 60 be thinner than the thickness L2 of the thick portion 48b of the opposing portion 60.

In the description above, as a method to have the thickness L1 of the thin portion 48a of the opposing portion 60 to be thinner than the thickness L2 of the thick portion 48b of the opposing portion 60, as shown in FIG. 23, the interval P1 between two first trenches 161 is formed to be narrower than the interval P2 between two second trenches 162 in the peripheral region 160B of the substrate 160. Even with the method above, the pressure sensor 100 capable of detecting the pressure value in the first zone and the pressure value in the second zone can also be manufactured.

### OTHER EMBODIMENTS

(1) The pressure sensor 100 performing the processing in FIG. 13 outputs a pressure value corresponding to the first voltage value when the first voltage value V1 is less than the predetermined value S, and outputs a pressure value corresponding to the second voltage value when the first voltage value V1 is greater than the predetermined value S. Herein, “the first voltage value V1 is less than the predetermined value S” corresponds to “a predetermined condition” of the present disclosure. The predetermined condition can also include other conditions. For example, the pressure sensor 100 or the electronic apparatus 700 can also include a liquid sensor. The liquid sensor is a sensor that detects a liquid. Further, the predetermined condition can also include a condition that a liquid is not detected by the liquid sensor.

As described above, the second zone is, for example, a zone of a pressure value in the sea. In view of the above, the pressure sensor 100 detects a pressure value in the first zone when the predetermined condition is satisfied. The expression “the predetermined condition is satisfied” refers to a condition in which the pressure sensor 100 is determined to be on flat ground (not located in the sea) since a liquid is not detected by the liquid sensor. On the other hand, the pressure sensor 100 detects a pressure value in the second zone when the predetermined condition is not satisfied. The expression “the predetermined condition is not satisfied” refers to a condition in which the pressure sensor 100 is deduced to be in the sea since a liquid is detected by the liquid sensor.

In case of the configuration above, a pressure value in the second zone can be detected when it is deduced that the pressure sensor 100 is in the sea, and a pressure value in the first zone can be detected when it is deduced that the pressure sensor 100 is on flat ground.

Further, the predetermined condition can also include other conditions. For example, the predetermined condition is a condition that a user inputs “an instruction for detecting a pressure value in the first zone” to the pressure sensor 100. In case of the configuration above, the pressure sensor 100 detects a pressure value in the first zone when the predetermined condition is satisfied (in case where the instruction is input). Further, the pressure sensor 100 detects a pressure value in the second zone when the predetermined condition is not satisfied (in case where the instruction is not input). With the configuration above, the pressure sensor 100 is capable of detecting a pressure value of a user-desired zone.

(2) In the embodiment, a configuration in which the thin portion 48a is the central part of the opposing portion 60 and the thick portion 48b is the peripheral part of the opposing portion 60 is described. However, a configuration in which the thin portion 48a is the peripheral part of the opposing portion 60 and the thick portion 48b is the central part of the opposing portion 60 can also be adopted.

### <Notes>

(1) An electronic component of the present disclosure comprises a cavity, a membrane deformable in accordance with a difference between a pressure inside the cavity and a pressure outside the cavity, and an arithmetic circuit. The membrane includes an opposing portion facing the cavity. One of a peripheral part and a central part of the opposing portion is a thin portion, and another one is a thick portion thicker than the thin portion. The arithmetic circuit detects a pressure value in a first zone based on a first output value in the thin portion. Moreover, the arithmetic circuit detects a pressure value in a second zone higher than the first zone based on a second output value in the thick portion.

According to the configuration above, the pressure value in the first zone and the pressure value in the second zone higher than the first zone can be detected by using one electronic component.

(2) In the electronic component of Note 1, the thin portion is the central part. Moreover, the thick portion is the peripheral part.

According to the configuration above, a thin portion 48a and a thick portion 48b can be formed by a simple configuration.

(3) In the electronic component according to Note 1 or Note 2, the arithmetic circuit detects the pressure value in the first zone based on the first output value if a predetermined condition is satisfied. Moreover, the arithmetic circuit detects the pressure value in the second zone based on the second output value if the predetermined condition is not satisfied.

According to the configuration above, either of the pressure value in the first zone and the pressure value of second zone can be detected based on whether the predetermined condition is satisfied.

(4) In the electronic component according to Note 3, the predetermined condition includes a condition that the first output value is less than a predetermined value.

According to the configuration above, the pressure value in the first zone can be detected when the first output value is less than the predetermined value, and the pressure value in the second zone can be detected when the first output value is greater than the predetermined value.

(5) The electronic component according to any one of Note 1 to Note 4 further comprises at least one strain gauge disposed in the thin portion, and at least one strain gauge disposed in the thick portion. The first output value is a first voltage value based on the at least one strain gauge arranged in the thin portion. The second output value is a second voltage value based on the at least one strain gauge arranged in the thick portion.

According to the configuration above, a strain gauge which is a generally known component can be used to detect the pressure value in the first zone and the pressure value in the second zone.

(6) In the electronic component according to Note 5, the at least one strain gauge disposed in the thin portion includes a first strain gauge, a second strain gauge, a third strain gauge and a fourth strain gauge. A series circuit in which the first strain gauge and the third strain gauge are connected in series and a series circuit in which the second strain gauge and the fourth strain gauge are connected in series are connected in parallel to form a first bridge circuit. The at least one strain gauge disposed in the thick portion includes a fifth strain gauge, a sixth strain gauge, a seventh strain gauge and an eighth strain gauge. A series circuit in which the fifth strain gauge and the seventh strain gauge are connected in series and a series circuit in which the sixth strain gauge and the eighth strain gauge are connected in series are connected in parallel to form a second bridge circuit. The first voltage value is a potential difference between the first strain gauge and the third strain gauge, and between the second strain gauge and the fourth strain gauge. The second voltage value is a potential difference between the fifth strain gauge and the seventh strain gauge, and between the sixth strain gauge and the eighth strain gauge.

According to the configuration above, compared to a configuration in which two strain gauges are respectively disposed at the central part and the peripheral part, detection precision for pressure values can be enhanced.

(7) The electronic component according to Note 6 further comprises a voltage terminal configured to apply a voltage to the first bridge circuit and the second bridge circuit.

According to the configuration above, the number of voltage terminals can be suppressed.

(8) The electronic component according to Note 6 or Note 7 further comprises a ground terminal configured to electrically ground the first bridge circuit and the second bridge circuit.

According to the configuration above, the number of ground terminals can be suppressed.

(9) In the electronic component according to any one of Note 1 to Note 8, a ratio of a thickness of the thick portion to a thickness of the thin portion is between 1.7 and 3.0.

According to the configuration above, the pressure value in the first zone and the pressure value in the second zone can be more appropriately detected.

(10) In the electronic component of Note 9, the ratio is 2.4.

According to the configuration above, the pressure value in the first zone and the pressure value in the second zone can be more appropriately detected.

(11) In the electronic component of any one of Note 1 to Note 10, the pressure value in the first zone includes atmospheric pressure.

According to the configuration above, a pressure value in the first zone including one pressure value can be detected.

(12) In the electronic component of any one of Note 1 to Note 11, a sensitivity of the pressure value detected in the first zone is greater than a sensitivity of the pressure value detected in the second zone.

According to the configuration above, the sensitivity of the pressure value in the first zone can be greater than the sensitivity of the pressure value in the second zone.

(13) A detection method of the present disclosure is a detection method for detecting pressure values by using an electronic component. The electronic component of the present disclosure comprises a cavity, and a membrane deformable in accordance with a difference between a pressure inside the cavity and a pressure outside the cavity. The membrane includes an opposing portion facing the cavity. One of a peripheral part and a central part of the opposing portion is a thin portion, and another one is a thick portion thicker than the thin portion. The detection method includes detecting a pressure value in a first zone based on a first output value in the thin portion. Moreover, the detection method includes detecting a pressure value in a second zone higher than the first zone based on a second output value in the thick portion.

(14) A method for manufacturing an electronic component of the present disclosure comprises: providing a substrate; forming a plurality of trenches in the substrate and extending along a thickness direction of the substrate; forming a space at ends of the plurality of trenches at an interior side of the substrate; forming a cavity and a membrane by closing the ends of the plurality of trenches at an exterior side of the substrate; and installing an arithmetic circuit. The membrane is deformable by a difference between a pressure inside the cavity and a pressure outside the cavity and includes an opposing portion facing the cavity. One of a peripheral part and a central part of the opposing portion is a thin portion, and another one is a thick portion thicker than the thin portion. The arithmetic circuit detects a pressure value in a first zone based on a first output value in the thin portion. Moreover, the arithmetic circuit detects a pressure value in a second zone higher than the first zone based on a second output value in the thick portion.

According to the configuration above, an electronic component capable of detecting the pressure value in the first zone and the pressure value in the second zone higher than the first zone can be manufactured.

(15) In the method for manufacturing an electronic component of Note 14, the forming of the plurality of trenches includes forming the plurality of grooves by etching. The forming of the space includes forming the space by etching. A diameter of one of the plurality of trenches at parts of the substrate corresponding to the thin portion is greater than a diameter of one of the plurality of trenches at parts of the substrate corresponding to the thick portion.

According to the configuration above, an electronic component capable of detecting the pressure value in the first zone and the pressure value in the second zone higher than the first zone can be manufactured by a simple method.

(16) In the method for manufacturing an electronic component of Note 14, the forming of the plurality of trenches includes forming the plurality of grooves by etching. The forming of the space includes forming the space by etching. An interval between two trenches at parts of the substrate corresponding to the thin portion is less than an interval between two trenches at parts of the substrate corresponding to the thick portion.

According to the configuration above, an electronic component capable of detecting the pressure value in the first zone and the pressure value in the second zone higher than the first zone can be manufactured by a simple method.

It should be understood that all points made in the embodiments of the present disclosure are illustrative rather than restrictive. The scope of the present disclosure is described and represented by way of the claims instead of the non-limiting embodiments, and is intended to cover all equivalent meanings and variations made within the scope in accordance with the claims.

1. An electronic component, comprising:
a cavity;
a membrane, deformable in accordance with a difference between a pressure inside the cavity and a pressure outside the cavity; and
an arithmetic circuit, wherein
the membrane includes an opposing portion facing the cavity,
one of a peripheral part and a central part of the opposing portion is a thin portion, and another one is a thick portion thicker than the thin portion, and
the arithmetic circuit is configured to
detect a pressure value in a first zone based on a first output value in the thin portion, and
detect a pressure value in a second zone higher than the first zone based on a second output value in the thick portion.

2. The electronic component of claim 1, wherein
the thin portion is the central part, and
the thick portion is the peripheral part.

3. The electronic component of claim 1, wherein the arithmetic circuit is configured to
detect the pressure value in the first zone based on the first output value if a predetermined condition is satisfied, and
detect the pressure value in the second zone based on the second output value if the predetermined condition is not satisfied.

4. The electronic component of claim 2, wherein the arithmetic circuit is configured to
detect the pressure value in the first zone based on the first output value if a predetermined condition is satisfied, and
detect the pressure value in the second zone based on the second output value if the predetermined condition is not satisfied.

5. The electronic component of claim 3, wherein the predetermined condition includes a condition that the first output value is less than a predetermined value.

6. The electronic component of claim 1, further comprising:
at least one strain gauge disposed in the thin portion; and
at least one strain gauge disposed in the thick portion, wherein
the first output value is a first voltage value based on the at least one strain gauge arranged in the thin portion, and
the second output value is a second voltage value based on the at least one strain gauge arranged in the thick portion.

7. The electronic component of claim 2, further comprising:
at least one strain gauge disposed in the thin portion; and
at least one strain gauge disposed in the thick portion, wherein
the first output value is a first voltage value based on the at least one strain gauge arranged in the thin portion, and
the second output value is a second voltage value based on the at least one strain gauge arranged in the thick portion.

8. The electronic component of claim 6, wherein
the at least one strain gauge disposed in the thin portion includes a first strain gauge, a second strain gauge, a third strain gauge and a fourth strain gauge,
a series circuit in which the first strain gauge and the third strain gauge are connected in series and a series circuit in which the second strain gauge and the fourth strain gauge are connected in series are connected in parallel to form a first bridge circuit,
the at least one strain gauge disposed in the thick portion includes a fifth strain gauge, a sixth strain gauge, a seventh strain gauge and an eighth strain gauge,
a series circuit in which the fifth strain gauge and the seventh strain gauge are connected in series and a series circuit in which the sixth strain gauge and the eighth strain gauge are connected in series are connected in parallel to form a second bridge circuit,
the first voltage value is a potential difference between the first strain gauge and the third strain gauge, and between the second strain gauge and the fourth strain gauge, and
the second voltage value is a potential difference between the fifth strain gauge and the seventh strain gauge, and between the sixth strain gauge and the eighth strain gauge.

9. The electronic component of claim 8, further comprising a voltage terminal configured to apply a voltage to the first bridge circuit and the second bridge circuit.

10. The electronic component of claim 8, further comprising a ground terminal configured to electrically ground the first bridge circuit and the second bridge circuit.

11. The electronic component of claim 1, wherein a ratio of a thickness of the thick portion to a thickness of the thin portion is between 1.7 and 3.0.

12. The electronic component of claim 2, wherein a ratio of a thickness of the thick portion to a thickness of the thin portion is between 1.7 and 3.0.

13. The electronic component of claim 11, wherein the ratio is 2.4.

14. The electronic component of claim 1, wherein the pressure value in the first zone includes atmospheric pressure.

15. The electronic component of claim 2, wherein the pressure value in the first zone includes atmospheric pressure.

16. The electronic component of claim 1, wherein a sensitivity of the pressure value detected in the first zone is greater than a sensitivity of the pressure value detected in the second zone.

17. A detection method for detecting pressure values using an electronic component including:
a cavity; and
a membrane, deformable in accordance with a difference between a pressure inside the cavity and a pressure outside the cavity, wherein
the membrane includes an opposing portion facing the cavity,
one of a peripheral part and a central part of the opposing portion is a thin portion, and another one is a thick portion thicker than the thin portion, the detection method comprising:
detecting a pressure value in a first zone based on a first output value in the thin portion; and
detecting a pressure value in a second zone higher than the first zone based on a second output value in the thick portion.

18. A method for manufacturing an electronic component, comprising:
providing a substrate;
forming a plurality of trenches in the substrate and extending along a thickness direction of the substrate;
forming a space at ends of the plurality of trenches at an interior side of the substrate;
forming a cavity and a membrane by closing the ends of the plurality of trenches at an exterior side of the substrate; and
installing an arithmetic circuit, wherein
the membrane is deformable by a difference between a pressure inside the cavity and a pressure outside the cavity and includes an opposing portion facing the cavity,
one of a peripheral part and a central part of the opposing portion is a thin portion, and another one is a thick portion thicker than the thin portion, and wherein
the arithmetic circuit is configured to
detect a pressure value in a first zone based on a first output value in the thin portion, and
detect a pressure value in a second zone higher than the first zone based on a second output value in the thick portion.

19. The method of claim 18, wherein
the forming of the plurality of trenches includes forming the plurality of grooves by etching,
the forming of the space includes forming the space by etching, and
a diameter of one of the plurality of trenches at parts of the substrate corresponding to the thin portion is greater than a diameter of one of the plurality of trenches at parts of the substrate corresponding to the thick portion.

20. The method of claim 18, wherein
the forming of the plurality of trenches includes forming the plurality of grooves by etching,
the forming of the space includes forming the space by etching, and
an interval between two trenches at parts of the substrate corresponding to the thin portion is less than an interval between two trenches at parts of the substrate corresponding to the thick portion.
